(19) United States
(12) Patent Application Publication
(10) Pub. No.: US 2021/0303557 A1
(43) Pub. Date: Sep. 30, 2021

(54) DATABASE QUERY AND VISUALISATION SYSTEM

(71) Applicant: COUNT TECHNOLOGIES LTD., London (GB)

(72) Inventors: Oliver PIKE, London (GB); Oliver HUGHES, London (GB); Edward HILL, London (GB)

(21) Appl. No.: 17/210,681

(22) Filed: Mar. 24, 2021

(30) Foreign Application Priority Data
Mar. 24, 2020 (GB) 2004231.3

(51) Int. Cl. G06F 16/248; G06F 16/242; G06F 16/2455

(52) U.S. Cl. CPC G06F 16/248; G06F 16/2456; G06F 16/2423

(57) ABSTRACT

The invention is a database query and visualisation system that is configured (i) to provide an interface with which a user can specify one or more queries; (ii) to generate a response to each query which is displayed as a table, graph or other visual representation; and in which the system is configured to process each query as a layer, where a layer is a node in a directed graph, and a set of nodes forms a notebook. The notebook is therefore made up of one or more layers; each layer generally corresponds to a step in the query. The notebook can be presented vertically down a scrollable page or as a dashboard. A query in a layer is transformed by the system into an exact, unambiguous, query in a database query language, such as SQL.

### CROSS-REFERENCE TO RELATED APPLICATIONS

This application claims priority to GB Application No. GB 2004231.3, filed on Mar. 24, 2020, the entire contents of which being fully incorporated herein by reference.

### BACKGROUND OF THE INVENTION

### 1. Field of the Invention

The invention relates to a database query and visualisation system; it enables a user to query a database, for example by inputting a natural language query into a user interface, and to receive a response displayed as a table, graph or other visual representation.

### 2. Description of the Prior Art

A typical, conventional data exploration tool has several drawbacks: it can take 20 hours or more to learn how to correctly use the tool—e.g. how to even correctly express a query; there are usually arbitrary limitations to the questions that can be asked; once a correctly formulated question has been asked, the tool can take 5 minutes to answer even a simple question.

The arbitrary limitations stem from the existing tools not making questions which are simple to ask, simple to compute an answer to. This makes sense in the context of the historical data analytics workflow, which has involved manipulating the data (pre-aggregating and feature engineering for example) to make this the case. This works well on traditional use cases, like a single, well-structured company database. However it does not work when the data is being bought in either from sources which have multiple uses (and so where pre-aggregation is unsuitable) or on the fly, where a data preparation workflow would be inappropriate.

Both the behaviour of notebooks in general (notebooks are already a known and well used concept in data analytics, for example Jupyter, Observable) and of semi-structured natural language or SQL to a database query in general (for an example open source implementation: ln2sql) have been implemented and described previously in the commercial, academic, open source and patenting literature; however both represent huge areas with large ranges of structural and implementation choices which can be made, particularly the latter case which is a problem that is known for being unsolved in the general case and where the limitations of popular implementations in e.g. home assistants are well documented.

There is a need for a database query and visualisation system that:
makes it significantly quicker and easier for people to ask questions of data,
decreases the time and effort needed to learn the system, and
removes arbitrary limitations to the questions that can be asked.

### SUMMARY OF THE INVENTION

The invention is a database query and visualisation system that is configured (i) to provide an interface with which a user can specify one or more queries; (ii) to generate a response to each query which is displayed as a table, graph or other visual representation; and in which the system is configured to process each query as a layer, where a layer is a node in a directed graph, and a set of nodes forms a notebook.

In one implementation, the notebook is therefore made up of one or more layers; each layer generally corresponds to a step in the query. The notebook can be presented vertically down a scrollable page or as a dashboard. A query in a layer is represented as a combination of some or all of:
1) SQL (or other database query language) statements
2) SQL (or other database query language) expressions
3) Free text which can be mapped to (1) or (2) by semantic substitution
4) Free text
5) Interface controls (such as click-, touch-, AR-, VR-based controls)

A query in a layer is then transformed by the system into an exact, unambiguous, query in a database query language, such as SQL.

### BRIEF DESCRIPTION OF THE DRAWINGS

FIGS. 1-5 show the Appendix D example, specifically layers a to e.

FIG. 6 shows the flow of information in the system.

### DETAILED DESCRIPTION

This section contains a description of the workings of the core data exploration system used in one implementation of the invention, called the Count® system.

The aims of the Count data exploration system

The aims of the Count data exploration system experience are:
to make it significantly quicker and easier for people to ask questions of data,
to decrease the time and effort needed to learn to use a powerful data exploration tool, and
to remove arbitrary limitations to the questions they can ask.

All of these are currently problems in people's data workflow with conventional data exploration systems. A typical data exploration tool can take 5 minutes to answer a simple question and 20 hours to learn from scratch—we are aiming to decrease both of these numbers by at least a factor of 10. As noted earlier, the arbitrary limitations stem from the existing tools not making things which are simple to ask, simple to do; this makes sense in the context of the historical data analytics workflow which has involved manipulating the data (pre-aggregating and feature engineering for example) to make this the case. This works well on traditional use cases like a single, well-structured company database, however it does not work when the data is being bought in either from sources which have multiple uses (and so where pre-aggregation is unsuitable) or on the fly, where a data preparation workflow would be inappropriate.

The user's interaction with the Count data exploration system centres around a reactive notebook (see Appendix D—discussed in more detail below)—this is a series of layers, each one of which generally corresponds to a step in their query and which can reference each other to answer increasingly complex questions. This provides a differentiation in behaviour from traditional products which do not allow this iterative approach.

Both in the interaction and in the implementation, there is a natural division between the behaviour of an individual layer and the behaviour of the notebook as a whole system.

The behaviour of an individual layer currently centres around a semi-free text input bar. Here the user can use either exactly written SQL, a mixture of SQL expressions and free text input, or free text input alone to specify their query, and they can reference things from the data they have bought in or in layers they have created further up the notebook. The response to the query, or the reason for an error, is then displayed to the user as a table, and possibly a graph, the behaviour of the layer is played back to them, and further queries are suggested. The way the layers, if they use or affect the result of another layer, behave with respect to each other is handled at a notebook level.

The development of this experience is driven by both the changing demographic of people analysing data and by the changing use cases due to the development of different data sources and use cases.

Both the behaviour of notebooks in general (notebooks are already a known and well used concept in data analytics, for example Jupyter, Observable) and of semi-structured natural language or SQL to a database query in general (for an example open source implementation: ln2sql) have been implemented and described previously in the commercial, academic, open source and patenting literature. However, both represent huge areas with large ranges of structural and implementation choices that can be made, particularly the latter which is a problem known for being unsolved in the general case and where the limitations of popular implementations in e.g. home assistants are well documented.

It appears that in other prior art realisations in this area, the work on notebook technology and on the technology used in a layer are disjoint. The Count data exploration tool looks, inter alia, at the interface between the notebook structure and the layer structure, by:
1) implementing a notebook such that it responds properly to the types of events provided by layers of the type used in a data analytics workflow; or conversely,
2) integrating the information provided by the surrounding notebook into the experience of a layer;
3) specifics of the implementation of the notebook and layers (even if treated in a stand-alone way).

### An Introductory Example

We begin with an introductory example to give some context to what is subsequently discussed in more detail.

Following that, we discuss the system from high to low level, at each stage describing the general working or flow of the system and giving details of the specific implementation we are using in the current experience.

The example is a demonstration of the workflow of the experience to provide some context for the description below.

We are looking at some data from the record of orders in a home and office supplies company (they have recorded the individual sales—the date of the order, the profit etc.); we are aiming to find out the spread in profits by the mode of shipping. The table contains columns including ‘Profit’ (a number) and ‘Ship Mode’ (a string).

Two trees are created—one has layers a and e in it; a being before e; and the other has b, c and d where b and c are used together to make d, the answer we are looking for, a and e are other bits of analysis we are doing around our main piece of work.

See Appendix D for the screen-grab of this example from a prototypal implementation.

Some key features are immediately visible:
1) The notebook structure, presented vertically down the page, is made up of layers—the repeating unit of a user query, a response (a table plus possibly a chart) and an interpretation. (Suggestions are not shown here.)
2) The form of the input which ranges from
   a. full (albeit simple) natural language in layers b and c, through
   b. semi structured input
      i. a, which uses a mixture of English words and SQL-type notation
      ii. d, which uses solely SQL expressions but notably without the full SQL syntax which is seen in
   c. layer e which includes the SQL syntax and keywords such as SELECT and FROM—this could be sent unaltered to the underlying SQL database
3) The significantly increased complexity of the executed SQL statements, for example in layer d—in particular an INNER JOIN is being performed without instruction from the user. This can only be done through the tracking of information and therefore knowing that the Ship Mode columns in layers b and c are the same thing and that at least one of them is a primary key on its table (this may seem obvious in this case, but that is because it is deliberately chosen to be simple—the algorithms for performing this tracking and logic are iterative on the layers and so can perform this same functionality in much more highly nested and complex cases)

Key Themes

Here, we highlight some important themes to help provide context and direction for the coming sections.
1) The system comprises a notebook—a tree or trees of nodes called layers. The notebook is
   a. Reactive—any update to a layer by the user or by the system causes a simultaneous update of any part of the notebook that is causally dependent on the updated layer
   b. Locally represented—the notebook tracks the schema of the query results from its layers and how those results interconnect locally, such that
      i. the notebook updates and provides e.g. charts and suggestions to the user with a minimum number of database calls and network requests
      ii. the behaviour of the notebook is indistinguishable from that that it would have without the local representation
2) The layers can either be created by the system based on existing layers in the notebook (suggestions) or created or modified by the user
   a. The method of interaction by the user allows unambiguous database calls to be made if the user understands the syntax and semantics of the underlying database
   b. The local representation causes no detectable negative change in the behaviour of the layers; i.e. any changes are purely additive and provide no restriction or degradation of the functionality.
   c. Freer methods of input can be used through the same interface as the exact input,
      i. allowing interaction with the system by users who do not have exact knowledge of the database's syntax, semantics, schema or contents, and
      ii. easing the interaction of users who do have some of that knowledge in either case the freer input is mapped to one or more exact queries which can be run by the database
   d. The user can refer explicitly (or implicitly) to the results of other layers in order to build up complex queries from much simpler parts.
3) The coupling of the notebook and the layers
   a. The layers receive information from the notebook which allows them to
      i. automatically insert joins into the queries
      ii. provide suggestions and charts in the context of the surrounding layers
   b. The queries sent to the database obtain any additional information required for the tracking of joins or other information needed to provide the notebook experience even when that information is neither requested by, nor displayed to, the user
4) That these methods are not specific to particularly
   a. the database type or its interface implementation (provided it fulfils conditions below)
   b. the representation of data within the database or in the local representation, for example relational, graph, entity-relationship
   c. the level of local representation used—some, all or none of the localisation of the functionality we discuss here
   d. the type of input used in the layers or the specific forms of output. Here we are describing a single, particular, implementation based around a semi-free text input and a table, graphical, suggestion and interpretation based output.

The Context of the Experience

The experience sits between the user and the source of data they are querying. This section describes what we are assuming about the system the experience is connected to. The assumptions are relatively minimal and therefore lead to the experience being applicable to a wide range of systems, including all standard database systems. We assume that the experience can be connected to a database. The database is assumed to have a deterministic interface, which will take an instruction and perform that manipulation on the underlying data returning the result if requested. The core experience is agnostic to the execution flow used within the database or nature of the language or format of the interface.

Specifically, we assume that we know the form of the output of the database for a given input, though we may not know the exact value of the data returned, the values within the tables. In relational databases this is commonly referred to as the database or table schema—the number of columns in the tables, sometimes the number of rows, and the columns' names and types along with the connections between the tables, and columns in different tables which are equivalent, these relationships are defined by keys, and the use of those keys to bring tables together by selecting rows with the same values of the key in the two tables are called joins.

If we refer to everything in the database—tables, columns and the entries in the database—as entities, a key point is that in the vast majority of practical cases the number of entries and the size of the information needed to be either processed, communicated or otherwise manipulated to find out about them vastly dwarfs the similar things for the schema.

We assume that the initial data has been loaded into the database, that we know the schema and that this is valid and ready for querying. This can either be provided or can be inferred—column types can be determined; joins can be found using record matching techniques and missing entities such as column names can be added.

The High Level System

We describe a notebook structure which consists of a series of layers which correspond to the user's queries. We describe how our assumptions about the database's behaviour and our control of the state allow us to use the database statelessly and with minimal or optional data retrieval.

The system is based around a notebook structure.

A notebook is a data structure which consists of a set of nodes connected in a directed graph. This graph becoming cyclic is a circular dependency and raises an error, and therefore we have a directed tree or trees formed from the nodes. By giving each node a unique, orderable, identifier we allow a strict ordering of nodes relative to a chosen node based on their distance along the tree from that node, with any ties being broken using the identifier. For any pair of nodes we can say that one comes before the other and can define a nearest neighbour to a node or group of nodes.

For any node we can provide a tree of all dependent nodes, or all nodes it is dependent on. If the notebook consists of more than one tree, we can split it into multiple notebooks, each based on one tree. The ordering of the nodes displayed to the user, or whether all or some are shown, is purely presentational.

Each node in the notebook is experienced as a layer and represents one query or one interaction by the user.

This ordering allows us to make the notebook reactive. This means that an update to one node precipitates the update of any other nodes which are affected by its value or behaviour. This can be achieved recursively on the set of updated nodes, which begins as the single user-updated node and spreads to its nearest neighbour at each step. This can be limited to nodes which come ‘after’ the updated node or can propagate back up the tree to nodes which come ‘before’. An update is this process by which the experience moves from one state to another.

There is a local state of the experience which consists of the current and past state of the notebook structure along with representational information for showing it to the user. The database also has a state, which (since it is typically a fully functional piece of software) can be very complex but is at least a list of the initial datasets and their contents.

Due to the size of the underlying data we need to have a many-to-one correspondence between different users' notebooks and the database, and therefore the experience is designed to hold all of the state, meaning that the database can be used as if it is entirely stateless (i.e., it does not hold any notebook state)—between each update the database could be entirely deleted and reloaded with an unchanged schema and contents without affecting the behaviour of the system.

The assumption about our knowledge of the database schema and the state allows us to simulate the vast majority of the behaviour of the database within the experience. For each query that is run we always know the number, types, names and key type of the columns returned and know if there will definitely be a single row (for example when non-grouped aggregation or filtering on a column with unique entries occurs). The only time we do not know whether the length of the returned table will be zero, 1 or greater than 1 is when a general filter or certain special functions have occurred. This allows many conclusions about the user's intent and the behaviour of the notebook to be determined without any interaction with the database, which is important for scalability.

Databases can have a variety of behaviour while fulfilling the conditions we need, and the experience acts to abstract those different database behaviours away from the user. These details are often problematic even to an expert user, particularly we abstract the strong typing of columns used in the majority of databases, the variation of function names, sampling, deferred scheduling, query parallelism, connecting to multiple databases or database copies and phrasing of queries to optimise caching. An example of the typing/function behaviour is that in SQLite strtimer(‘% Y’, column) returns a column containing the year of a series of dates in column (which is untyped and is cast on-the-fly by the database), whereas in PostgreSQL date_partCyear; column) is used and column must have a date or time type. This abstraction means that beyond unalterable performance differences, the user should not have to alter their behaviour and should not see different behaviour if different databases are used beneath the experience.

The ability and necessity of using a local state of the notebook is dictated by its use in a context where its underlying system is a database—this context is one where there are enough assumptions and restrictions on the behaviour of underlying system such that simulation of a significant fraction of its behaviour can be performed locally without having to replicate a significant fraction of that underlying system, but also where there is value in performing the local simulation that since it provides significant advantages in terms of speed and scalability relative to repeated interaction with the underlying system.

We note that these advantages would hold for other underlying systems where substantial parts of the behaviour are deterministically based on a small amount of information, but where the exact behaviour can only be derived by a costly direct testing of the system, or where there is benefit in having a distinct local state of the system when the global state can then be updated to replicate at a future time (see ‘Other Uses’).

The key interest in the system as a whole is how the state of the notebook informs the behaviour of the layers and how the state of the layers informs the behaviour of the notebook; we will discuss the behaviour from each direction.

Operation of a Layer

A layer is the basic atomic unit of the notebook, holding a local state between update operations precipitated by the user or the notebook.

A layer holds a state which includes, but is not limited to,
1) the user's interaction with the layer e.g. text, clicks or actions they have performed (e.g. maximum profit by ship mode),
2) the query the layer is representing to the user (SELECT MAX(Orders.Profit) AS col1, Orders. ‘Ship Mode’ FROM Orders GROUP BY Orders. ‘Ship Mode’),
3) the query run by the database,
4) the results of that query returned by the database, including
   a. the actual result, in the case of a normal, relational database, a table
   b. a visual representation of the result
   c. a human readable interpretation of the query and other behaviour e.g. “The maximum of profit for each “Ship Mode” displayed as a bar chart”
5) any errors or warnings; none in this case, but for example,
   a. errors due to the query in the layer itself e.g. none of the tokens in the input could be recognised
   b. errors due to the attempt to update the notebook, e.g. if there was a circular reference

As alluded to in (2) and (3), the query the layer represents to the user and the query run by the database may be different; this is because the layer has to hold additional information regarding the key which sometimes has to be derived from knowledge of the entries in the database. The key is needed for the notebook to know how to bring the result of two layers together but need not be seen by the user. A simple example would be if we selected columns of a table which did not include the key, but then wanted to join another table to that new table—this can only be performed because the key column is present in the query run by the database and in the state of the layer, but not in the table the user sees or interacts with.

When two tables are brought together in a layer, a set of rules are used to determine which columns can be joined on and then perform the join, see Appendix A.

A layer is stateful and holds that state until some update event occurs. This can be caused by:
1) The user interacting with the layer, or
2) An update event propagating through the notebook from another layer.

The following sections now describe those two interactions.

We also note the extension that an interaction with the layer or with the notebook by the user or by a notebook event can produce a query or other behaviour which can be better represented as more than one layer. In this case the layers may be created along with the necessary notebook machinery around them. For example
1) we may want to represent a layer such as average sales by region for “staplers” as a single layer outputting that as a single query, or as two layers, the first of which shows the root table filtered for “staplers” and the second of which shows the average sales by region from that second table.
2) Conversely, we may want to compress two layers—a filter for staples followed by average sales by region—into a single layer.
3) These changes may be caused by a user interaction or during the update of the notebook, for example in order to ease the presentation of a suggestion.

The User Interaction with the Layer

Interacting with a layer forms the bulk of the user's interaction with the system. The layer provides the user with an interface to query the database using entities from the data which have been imported from the results of previous layers.

This interface can take a huge number of forms, from free text input to click-based to VR/AR etc. —in each case we are assuming that the user has the ability to use that interface to give an intent to use given functions provided by the database on the concepts which they think are in it.

Any functionality provided by the database can be obtained unambiguously and with absolute certainty by a user who has knowledge of the database's operation. In particular:
1) Despite the use of the experience to hold the state, not the database as would usually be expected, there is no degradation of behaviour in our case, that is, anything which could be achieved through the canonical interface to the database can be achieved through ours. The current implementation uses a SQL database and operates such that each layer is perceived by the user as a table with the same name as the layer. The user can then type in an arbitrary SQL statement referring to one of more of the imported tables and the existing layers and receive the same result as if they had run that operation on the database directly.
2) The system is therefore Turing complete—colloquially, you can compute anything you want to—if the database is.

The usual interfaces which connect directly to databases allow such functionality through a high level of structure and formalism, often to a level which is inappropriate for the query which is being asked.

In the example above, the value ‘Second Class’ only occurs in ‘Ship Mode’ in the table. Using SQL, we have to type (the quotation mark types are important):
SELECT*FROM Orders WHERE “Ship Mode”=‘Second Class’ or
SELECT*FROM Orders WHERE Ship Mode′=‘Second Class’

However
SELECT*WHERE “Ship Mode”=‘Second Class’ FROM Orders

Produces an error; no query is run
SELECT*FROM Orders WHERE ‘Ship Mode’=‘Second Class’
   Runs and produces no data (since it produces data where the string literal ‘Ship Mode’ equals the string literal ‘Second Class’ which is never true)

Such behaviour is surprising to a non-expert and frustrating to an expert, in particular it runs counter to the expectation from using web-based shallow search e.g. Google, where “secnod class” [sic] would be acceptable.

However, more ambiguous input can be entered through the same interface, allowing ambiguous input, yet having the ability to enter text which is interpreted exactly.

We describe implementations of this input system in Appendix B.

Suggestions as to further queries the user may wish to perform are produced based on the content of the layer and of previous layers, we describe implementations of these in Appendix F.

Graphical output of the query is automatically generated. We describe the rules for generating these charts in Appendix C.

It is known that the interpretation of the query is simple to produce since the query is known exactly, it is also simple to name newly produced columns since it is known exactly what operation produced them. For example the query average sales by week will produce a query of SELECT AVG (“Sales”), strfime(‘% W’, “Date”) FROM “Orders” GROUP BY strftime(‘% W’, “Date”) which can be simply played back as average sales and the week of date from the Orders table (for example) and the returned columns can be named average_sales and week_of date.

At any time, multiple results (tables, charts, interpretations, suggestions etc.) due to multiple different interpretations of the user's input or other intent may be displayed. The user may then select from these. The input system is designed in part to limit the number which need to be displayed (preferably to one) by helping the user to refine their intent during input.

Operation of a Notebook

When a layer updates, it has to ensure that any information it requires from other layers has updated as well. When a layer is updated we firstly must determine if the change is local, if it propagates and if so, if it causes a local or propagating change to other layers.

Local changes include a change to the presentation of the node, for example some changes to how the visual is displayed or how a table is seen to be sorted or how many rows are visible, or the inclusion of another column in the query which is unused elsewhere—they will cause no change to surrounding layers.

Propagating changes fire an event to surrounding layers—when a layer is updated in this way then every layer which depends on that layer must then update. For each layer asked to update:
1) See if it propagates backwards to any layers, ask these to update and wait until they have, for example if the query now requires information which would have to be passed from previous layers: average sales by town; max of that is changed to average sales by town; max of that by week, then we must propagate the need for by week to the previous query, giving average sales by town and week; max of that by week. This propagation will continue into the import routines, varying the behaviour of the parsing of a column in typed import.
2) Attempt to run the same database query as before. Sometimes, the changes to the layer will cause other layers to no longer work as expected, a hierarchy of behaviour can then occur. The success or failure of a query can be determined in the majority of cases using the local state, for example it can correct changes to column type, change the JOIN required etc. and so, if the local state determines the query works we can continue to (5).
3) If (2) fails attempt to reparse the user interaction in the new context of the already updated layers.
4) If (3) fails raise an error. There are many options as to how an error can be represented, i.e. whether it is represented at
   a. the layer whose update precipitates another layer's failure,
   b. the layer of the original user interaction
   c. the layer which fails, or
   d. any combination of those or on the route between (for example through a colour change of the displayed layer etc.)
5) Finally, propagate the change to layers after this layer.

Once this is complete, the notebook can be used to produce the query at each layer
6) The queries are run. There should be no errors from the database, since all queries have been validated by the notebook, however there may be empty tables created (with no rows) and this can be returned as a warning/error by the notebook. Sometimes this is the required result e.g. Staplers in London may return many rows of staplers sold in London, but that Staplers in Bristol returns no rows is a result in itself—that no Staplers were sold in Bristol.

The queries which are run could be run at any time i.e. after each instance of (5) or can be run at the end after all changes have been made.

The queries may be run using intermediate tables corresponding to the layers or can be written by nesting the queries so that no intermediate tables are formed—this leads to different performance in databases where table creation involves distinct behaviour, for example disk writes. Explicitly, in SQL:
CREATE TABLE table_1 AS SELECT [selects] . . .
SELECT [selects] FROM table_1 . . .

may be compared to
SELECT [selects] FROM (SELECT [selects] . . . ) AS table_1 . . .

or
WITH table_1 AS (SELECT [selects] . . . ) SELECT [selects] FROM table_1 . . .

Since the state at any time is known, and is very small, it is simple to have undo functionality.

The structure and operation of a notebook also lends itself to the inclusion of other types of layer, not linked to the notebook-layer interaction we are describing here. Layers could provide space for
1) plain and/or richly formatted text, images, videos, other media, hyperlinks, etc. input to explain the analysis around them
2) an interface for connecting to the imported data, this could be particularly useful if the data is streaming or updating
3) certain special functions, either allowing the insertion of
   a. functions which take many parameters and which are very much unsuited to interacting with through a flexible interface
   b. basic operations e.g. showing the underlying tables
4) management of output events, for example testing on a condition in the notebook to fire an external event, for example an e-mail or a tweet
5) insertion of code written in an arbitrary coding language to provide importable and arbitrary functionality in languages better suited to this than the languages which are typically used to interface to databases.

These other layers can also provide entities which could be interacted with in other layers, for example the outputs of the special functions (3), the imported data (2) or some information or metadata regarding the media or text (1).

Other Uses

Other uses of such a system—one where a local stateful notebook structure
1) acts to simulate a connection to another system using some information about the result of an action on another system, with a substantially reduced need to test that remote system
2) allows complex operations to be built up iteratively, with the validity of a given series of operations evaluable with complete recall, and
3) allows the action on the system to be deferred until such a time as the result of the action needs to be known include:
1) Systems with readily calculable upper or lower bounds, i.e., where the computational time needed to calculate an upper bound, a lower bound or validate that a prohibitive condition has or has not been triggered is significantly lower than that needed to find the actual answer, for example
   a. Design of fluid flow.
      i. It is known that the flow of a liquid in a pipe becomes turbulent above a certain velocity for a certain fluid and pipe cross-section, it is known that the velocity in a pipe is its average flow rate somewhere, and it is known that the sum of flows at junctions is zero. Therefore, the experience would allow a pipe system to be built simply and iteratively, and at each point testing very quickly and locally for cases of turbulence—which are bad for the system—for the upper bound to the throughput of the system. On completion, or during the design of larger scale fluid models, which take many days to run could calculate the exact chances of turbulence, for example in the junctions themselves, however significant benefits have been derived from responsive, plausible design, and not wasting valuable computer or human time on set-ups which can quickly be seen to be unfeasible.
      ii. Similarly electrical networks, computer networks, task scheduling, etc.
   b. Delivery, route finding
      i. Validating the plausibility of a new route. The notebook can be used to place new constraints on the route in an iterative manner, is it still possible to complete deliveries within a specified time? The solution is the Travelling Salesman Problem which is very time consuming, however showing that it is definitely not possible can be shown very quickly by, for example in a metric space, Christofides algorithm. If it is no longer possible, constraints can be removed or updated reactively in order to solve the problem. Again, the planning can proceed iteratively and locally only using the costly algorithm in a plausible case for validation or for calculating the exact time before dispatching the driver.
   c. Structural engineering and other eigenvalue problems
      i. Again, finding a single, extremal eigenvalue to show that a setup is implausible, unsafe or in some other way unsuitable is far quicker than finding the entire eigenvalue spectrum
2) Systems which are readily subsampled, under-resolved or approximately solved
   a. Allows a fast, local indication of the eventual result followed by an evaluation of the precise answer
      i. Subsampling:
         1. Database querying with a local, subsampled database and then running the full queries remotely
         2. Downsampling and/or trimming in duration in signal, music, video processing
      ii. Under-resolution or approximation, for example:
         1. Radiation exposure and flow—approximation using for example diffusive or Monte Carlo methods—and then performing a simulation more detailed in terms of temporal, spatial or spectral resolution remotely
         2. Differential equations, for example in finance, which can be solved implicitly with a large step size while missing some short-time behaviour and then solved to convergence remotely

### APPENDIX A: TRACKING AND DETERMINING KEYS AND JOINS

We will use the naming conventions used in SQL relational databases to allow connection with the literature and to provide examples, but this does not exclude implementations not using that technology.

Keys on tables relate entries between tables, describing which columns contain entries which are unique or which columns contain entries which are unique in another table.

A primary key is a column or group of columns which uniquely identifies any row in a table for example an employee id column.

A foreign key is a column or group of columns in a table which are a primary key in another table. The column of towns in a database of addresses can be linked to the column of towns which is the primary key of a table which is a list of towns and their crime rate.

A candidate key is the same as a primary key, but has not been chosen as the primary key (many databases enforce the requirement of one primary key, though this is not obvious to a lay user)

Tracking Keys

A query on a table can have three types—non-aggregating filtering, non-aggregating constructing and aggregating
1) In non-aggregating filtering queries, the primary, candidate and foreign keys on the original table are retained in the result since all that has occurred is a filtering of rows (a SQL WHERE statement) or columns (a SQL SELECT statement), a reordering of rows (a SQL ORDER BY statement), or the addition of new columns (by applying a function to existing columns or JOINing to another table where that JOIN is INNER or LEFT). The behaviour of these keys can be determined solely based on the table schema. New candidate keys or foreign keys can also be created, for example if the filtering renders a column which was non-unique unique or if it restricts the entries in a column such that all entries are now contained in a column of another table. The behaviour of these keys requires knowledge of the contents of the tables.
2) In non-aggregating constructing queries, new columns are added to the table. These can be candidate or foreign keys however the behaviour of these keys in general requires knowledge of the contents of the tables. However, if the new column is a function of existing primary/candidate key columns and retains all the information of that primary/candidate key (e.g. a suffix is added to a column of text, a constant multiplier is applied to a column of numbers) then it is known the new column is a candidate key.
3) In aggregating queries, the columns which are aggregated by (a SQL GROUP BY statement) are known to be a primary key on the table created and the columns in the original table are then known to be the corresponding foreign key, the behaviour of these keys can be determined solely based on the table schema.

There may be other candidate keys or foreign keys created, however the behaviour of these keys requires knowledge of the contents of the tables.

Any other queries can be seen as chains of these query types (for example binning is (2) followed by (3) and a SQL HAVING statement is (3) followed by (1), although these are often mixed together in database calls)

Despite the requirements on knowing the table contents to solve the general case, much of the behaviour in general use can be determined solely using the table schemas.

Performing JOINs

From the knowledge of the series of primary and foreign keys in the database at any time, JOINs can be performed automatically.

First take the tables in the database and construct a directed graph which has an edge pointing from one table to another if the primary key of the first links to a foreign key of the second.

Now, take two tables to be joined, and follow all possible paths from the tables through the directed graph. These paths either do not intersect, intersect in one place, or intersect in multiple places.

Note that multiple paths can intersect in the same place and provide different results since the behaviour of the eventual JOIN is dependent on restriction of the values passed along the paths.

We provide simple examples of where the paths cross using two base tables, Table A with two columns ‘price’ and ‘colour’ and Table B with ‘profit’, ‘town’ and ‘product’.

If they do not intersect, there are two possible behaviours:
1) Return an error—the two tables cannot be connected
2) Perform an unrestricted CROSS JOIN. If the two tables have primary keys, a new primary key which is their cross product is formed.

For example: we try to join Table B with Table A, we return either an error, or a table which contains five columns ‘price’, ‘colour’, ‘profit’, ‘town’, and ‘product’.

If they intersect once, then,
1) if the foreign key on which they intersect is the same, join on the primary keys, with the standard behaviour being an INNER JOIN. If they have an empty intersection the resulting table will be empty, however this is the required result.*
   For example, we join ‘average profit by town’ with ‘maximum profit by town where the county is X’; we can therefore join the tables directly on their ‘town’ columns
2) If the one foreign key on which they intersect is contained within the other, JOIN onto the primary key of the table whose foreign key is contained in the table whose foreign key contains
   We join ‘average profit by town’ with ‘maximum profit by product and town’, we join the former to the latter using the ‘town’ column.
3) if the foreign key on which they intersect is entirely different, perform a JOIN via that table, either
   a. Without modifying the queries before the current one
      i. Through every row, obtaining a new table with the same number of rows as that joining table
         We join ‘average profit by town’ with ‘maximum profit byproduct’ by reading down the rows in Table B and adding two columns from the values of ‘town’ and ‘product’
      ii. Though the distinct combinations of rows, obtaining a new table with a number of rows at most the product of the sizes of the primary keys and a new primary key on it which is their union.
         We firstly find the unique combinations of ‘town’ and ‘product’ from Table B and then do the same as (3)(a)(i) on that table
   b. With modification of the previous queries
      i. Make one of the tables to be JOINed contain a foreign key for every primary key of the other tables.
         We modify the first query to be ‘average profit by town and product’ and then use case (2)

If they intersect more than once, then perform the same operations as on a single intersection and return multiple options to the user.

Lack of Implementation Specificity

The above description has used the notation and database structure associated with a table-based relational database; however, the concepts are not confined to that implementation. In the other commonly used representation, an entity-relationship form which underlies graph databases and much of the research on human interfaces to databases, visualisation theory etc., the rules applied are very similar to those above, however when aggregating queries are performed, the results are classified by the primary key which is formed, the primary key defining an entity in the ER representation. The operation (*) is therefore just an operation on a single table. The other operations are also significantly simplified if the columns contain hierarchies, which is often the case (for example if product were replaced with county, with town to county being a many to one mapping), however if no hierarchies are present, there is little to recommend either implementation over the other. The use of an ER representation in the presence of hierarchies (or equivalently recording those hierarchies in the table representation) also reduces the load on the database since it allows the determination of candidate keys and of empty filters without using the database in many common cases.

The way in which the information is displayed to the user is independent of whichever underlying implementation is used.

Joining on Things which are not Usually Seen as Keys

A key concept in data is time, which is not usually seen as a key, however we track and allow interaction between time columns in the same way as with keys. Any time column can be joined to any other since we can say whether any two times or time ranges are equal, or contained within one another or disjoint. Joining may involve aggregation or projection and may therefore involve a choice of how to operate on other columns or on the time columns themselves. Time columns can also be seen as primary or candidate keys if the time intervals within them are unique and disjoint, and in a similar way to any other column can be used as one of the columns in a multiple column key.

Similar observations apply to any non-categorical column where the equality, containment or disjointness of any two entries can be specified. For example, numerical ranges, numbers, geographical points, lines, areas or volumes.

### APPENDIX B: THE INPUT

We describe manifestations and features of a system which can simultaneously handle ambiguous and entirely unambiguous input.

Input from the user is mapped via tokens, which include the entities from the database, entities from previous layers, special commands, functions, literals, words in the base language, for example English, and other input from the user e.g. annotations and comments
1) The system can operate such that at each stage of the parsing of the text which is entered, exact SQL or SQL expressions are taken to have precedence_over any other possibility.
   a. For example: Sub-Category=‘S tapler:z’ returns nothing, since ‘Staples’ does not exist in that column
   b. For example: Sub-Category >‘D’ returns all members of Sub-Category which are lexicographically after ‘D’ since it is a valid SQL expression
   c. For example: Sub-Catgory >‘D’ has the same behaviour since first Sub-Catgory is spelling corrected (see (2)) to ‘Sub-Category’ and then the phrase is an exact SQL expression.
   d. For example: S ub-Categog >D returns no results since D is not corrected to an entry; nor does S ub-Categog=D since D is not corrected to anything in the Sub-Category column.
      i. This is the case because while such ‘corrections’ could be made, it causes far too high a level of ambiguity in the parsing of the text, and the user has methods through (a)-(c) to obtain the behaviour they want in these cases.
   e. This could be loosened to having a high probability relative to any other possibility based on data from larger scale usage
2) A spelling corrector is provided which can provide mappings from misspelt words or words to tokens.
   a. Misspellings; using for example the Norvig (2009) [https://norvig.com/ngrams/ch14.pdf] method
   b. Words which have been accidentally split or joined together
   c. The current implementation uses edit distances (i.e. characters being changed, re-ordered or deleted) up to 2 times.
   d. Permutations in the ordering and grammatical phrasing of strings, for example ‘UK GDP’=‘GDP of the UK’
3) The system can take into account stop characters such that parts of the phrase can be unambiguously parsed together.
   a. This is necessary to resolve syntactic ambiguity in English and for allowing operations which do not have a set precedence or where that precedence is not widely known (for example ‘A and B or C’ could either be ‘A and (B or C)’ or ‘(A and B) or C’) to be resolved during query entry rather than by displaying multiple results
   b. This is advantageous for allowing multiple nested queries to be written into a single text entry without a very large number of possible parses being formed.
4) A named entity parser is used to resolve
   a. the multiple different ways in which, for example, dates and numbers can be represented (e.g. ‘25 Feb. 2019’ vs ‘19/02/25’), as well as
   b. colloquial dates e.g. ‘a week last Thursday’
   c. currencies and other formatted numerical values
5) Autocompletion, which we define as the display of results or parts of results during construction of the query, rather than after the query has been somehow submitted by the user) provides the user with the ability to disambiguate as they type, it can be used to
   a. provide help knowing what columns, tables, entries or functions are available, for example Stap giving Stapler as an option
   b. resolve some ambiguity as to entries which occur in multiple places in the dataset before the phrase is sent into the full parser. For example, if an entry Stapler for example occurs in two different columns, autocompletions to [Stapler in Column 1] or [Stapler in Column 2] can be returned.
6) Disambiguation post entry, which we define as the display of multiple results for given tokens or combinations of tokens, similar to autocomplete but not necessarily during typing. This can include, but is not limited to
   a. Correction of spellings or ambiguous tokens where there are multiple sensible options e.g. minim giving [mini in Column 1], [mini in Column 2], minimum (a column), minimum (the function)
   b. Explanation of choices made (e.g. average giving one of mean, median, mode) Multiple tokens, or combinations of tokens, can be disambiguated, where there may be several choices for each group—showing all possible combinations or results for all possible combinations would be prohibitive.
7) Implicit columns can be included by the use of certain structures.
   a. For example, using date binning functions or datetime operator expressions: average price since 2015 gives average price where order date>2015-01-01
8) Entries, columns and records from other layers or from the imported tables can be directly referenced, either through
   a. A unique name if no other tokens with that name exist, for example in the first query on an imported table
   b. A unique name through additional specification, not limited to table.column e.g. Orders.Sales, orders.sales, Orders. “Order Date”
   c. A non-unique name which can then return multiple results (or prior to that multiple autocompletions) with precedence of the results as regards, for example the proximity in the notebook history of the entity, determining their display to the user
9) Entries, columns and records from other layers or from the imported tables can be inferred
   a. Singly: if text is inputted which does not form a query on its own, but would if a result of an appropriate type from a previous layer were included. For example: average profit by region then >100 will infer that, since >100 is not a query on its own, that the numerical column outputted by average profit by region can be used to ‘complete’ the query
   b. Multiply: if text is inputted which does not form a query on its own, but would if results of appropriate types from previous layers were included. For example: average profit by region then maximum sales then >will infer that, since >is not a query on its own, that the numerical column outputted by average profit by region and the numerical value outputted by maximum sales can be used to ‘complete’ the query
   c. We note that these overlaps with (7) in this Appendix and also with Appendix D 3(a) and 2(d) (i)
10) The tokens found are pulled together into SQL queries (defined at https://www.sqlite.org/lang_expr.html). For example ‘average price’ is mapped to a token representing AVG (the average operator) and ‘price’ (a column in a table). These can create a SQL expression AVG(‘price’) using the 6^{th} branch on the definitions page referenced above. These expressions are then bought together to make a query, since certain expressions can only occur in certain part of a query in SQL
11) A slight modification to (1) can be used to free up the usage of “ ”, ‘ ’, ″, [ ]which have specific meanings in SQL, the nuances of which may be not be suitable for an average user.
   a. “ ”: This leads to a slight ambiguity in the WHERE clause of a SQL expression, but allows “ ” to be retained as a grouping operator as in other free input interfaces e.g. average price in “North Yorkshire”—if “ ” are used as in SQL here, “North Yorkshire” must be taken to be a column name, average price in ‘North Yorkshire’ would correspond with the SQL definition of North Yorkshire as a string literal.
   b. [ ]: Are used equivalently to “ ” in SQL but by ignoring this role they can then be used for, for example, the much more common array element operator e.g. a[2] is usually the third element of array a (since arrays are usually indexed beginning from 0).
12) Columns and entries can be referred to by index by using table.n where n is the number of the column from the left of the table as displayed to the user. This can be used unambiguously with SQL by using “ ” to escape numbers if the actual name of a column is a number. Entities can also be referred to by their row in the table using for example Orders.Sales.2 or Orders.Sales[2]. In both cases, and similarly to (11) we are extending away from standard SQL in a direction towards the behaviour of most programming languages.

### APPENDIX C: DETERMINING CHART TYPES

When the query is returned from the database, a series of chart types are selected for display to the user. The quality of the user experience is tied to the selection of charts and the order in which they are displayed.

The process:
1) Get the schema of the query result, augmented with the cardinalities and domains of the columns
2) For each of the available chart types in Table 1, apply all of the hard constraint predicates listed in Table 2. If any fail, stop considering that chart type.
3) For each passing chart type, apply all of the soft constraints listed in Table 2. Increase the ranking if a positive constraint passes, decrease it if a negative one passes. Currently all rankings are set to 1, however user usage data will be used to improve this through people's selection of chart
4) For each passing chart type, apply in order its list of mapping preferences to assign columns to axes
   a. x ( . . . OnX),
   b. y ( . . . OnY),
   c. colour ( . . . OnC),
   d. radius ( . . . OnR), and
   e. transparency ( . . . OnT)
   Any leftover columns are mapped to the visual in arbitrary order.
5) Use the column-axis mapping to construct the visual using the API to the plotting library.

TABLE 1
Available chart types

| | | | Any number |
|---|---|---|---|
| 2 columns | 3 columns | 4 columns | of columns |
| Scatter | Scatter colour | Scatter colour radius | Multiple scatter |
| Line | Line colour | 2 scatters | |
| Filled line | Filled line colour | 2 heatmaps | |
| Bar | Heatmap | | |
| Area | Stacked bar | | |
| Waterfall | Grouped bar | | |
| | Stacked area | | |
| | Multiple scatter | | |

TABLE 2
Predicate list
“N”/“num”, “T” and “S” represent numeric, time and string types respectively; “agg”
represents an aggregation; “card” represents cardinality; “X”, “Y” and “C” represent the
X, Y and color axes respectively; “Na” represents and aggregated numeric column.

| Chart | Hard | Soft positive | Soft negative | Mapping |
|---|---|---|---|---|
| type | constraints | constraints | constraints | preference |
| Scatter | | allHighCard | | timeOnX |
| | | | | stringOnY |
| Line | | allHighCard | oneToMany | timeOnX |
| | | atLeastOneNorT | | aggOnY |
| | | | | stringOnX |
| | | | | numOnX |
| | | | | numOnY |
| Filled | oneToMany | atLeastOneHighCard | | numLikeOnY |
| line | atLeastOneN | atLeastOneLowCard | | |
| | atLeastOneNotVeryHighCard | | | |
| Bar | oneToOne | oneNa | allHighCard | stringOnY |
| | | | | aggOnY |
| | | | | aggOnX |
| | | | | timeOnX |
| Area | | oneToOne | oneToMany | timeOnX |
| | | atLeastOneMediumCard | | aggOnY |
| | | | | stringOnX |
| | | | | numOnX |
| | | | | numOnY |
| Waterfall | oneToOne | | | aggOnY |
| | atLeastOneMediumCard | | | |
| Scatter | | oneToMany | | stringsOnXY |
| colour | | | | highCardStringOnY |
| | | | | timeOnX |
| | | | | numLikeOnX |
| | | | | numLikeOnY |
| Line | atLeastOneNorT | oneS | noNorT | timeOnX |
| colour | bothNonAggMultiValued | atLeastOneMediumCard | someNRelativelyLowCard | aggOnY |
| | atLeastOneNonAggLowCard | | oneToMany | lowCardOnC |
| | | | | stringOnX |
| | | | | numOnX |
| | | | | numOnY |
| Filled | oneToMany | | | numLikeOnY |
| line | atLeastOneN | | | lowCardOnC |
| colour | atLeastOneLowCard | | | timeOnX |
| | atLeastTwoNotVeryHighCard | | | stringsOnXC |
| Heatmap | oneNa | twoS | | timeOnX |
| | bothNonAggMultiValued | | | aggOnC |
| | | | | numOnC |
| | | | | stringsOnXY |
| | | | | numOnX |
| | | | | numOnY |
| Stacked | oneNa | twoS | | numLikeOnY |
| bar | atLeastOneNonAggLowCard | atLeastOneLowCard | | lowCardOnC |
| | strictlyPositiveAgg | | | strings OnXC |
| | | | | timeOnX |
| Grouped | oneNa | twoS | | numLikeOnY |
| bar | atLeastOneNonAggLowCard | atLeastOneLowCard | | lowCardOnC |
| | | twoNonAggLowCard | | strings OnXC |
| | | | | timeOnX |
| Stacked | oneNa | twoS | | timeOnX |
| area | atLeastOneNonAggLowCard | | | aggOnY |
| | strictlyPositiveAgg | | | lowCardOnC |
| | | | | numOnX |
| | | | | numOnY |
| Multiple | atLeastTwoN | | | uniqueOnX |
| scatter | upToOneDifferentType | | | timeOnX |
| Scatter | | | | numLikeOnR |
| colour | | | | lowCardOnC |
| radius | | | | stringsOnXY |
| | | | | highCardStringOnY |
| | | | | timeOnX |
| | | | | aggOnY |
| | | | | numOnX |
| | | | | numOnY |
| 2 scatter | atLeastTwoN | | | uniqueOnX |
| | upToOneDifferentType | | | timeOnX |
| 2 heatmaps | twoNa | | | stringsOnXY |
| | twoS | | | |
| Multiple | atLeastTwoN | | | uniqueOnX |
| scatter | upToOneDifferentType | | | timeOnX |

### APPENDIX D: THE EXAMPLE

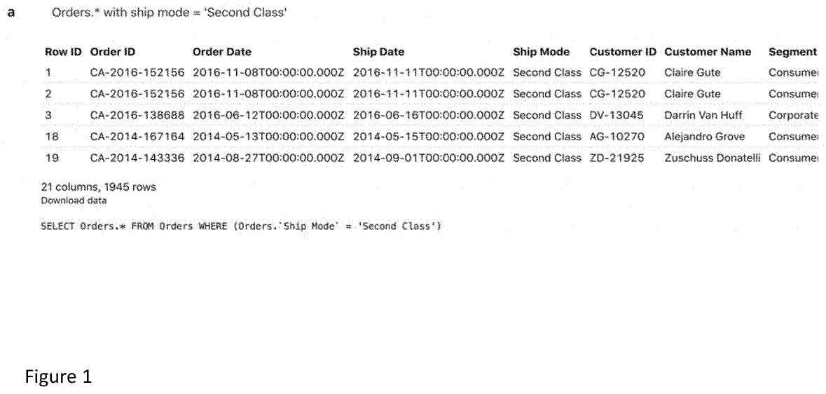

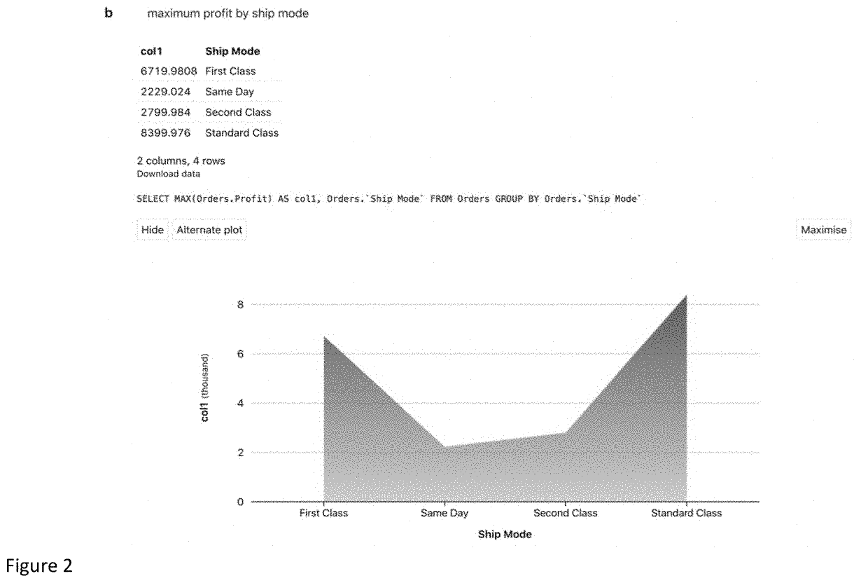

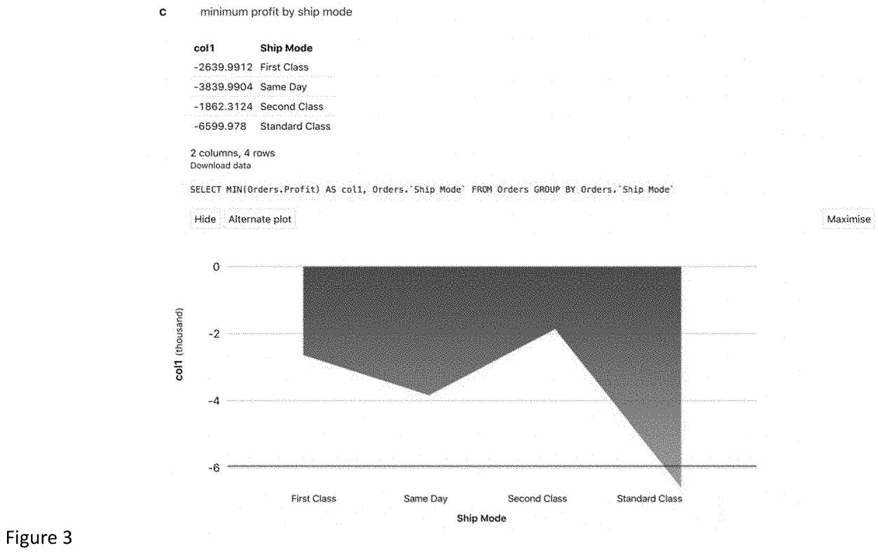

See FIGS. 1, 2 and 3.

### APPENDIX E: FLOW OF INFORMATION

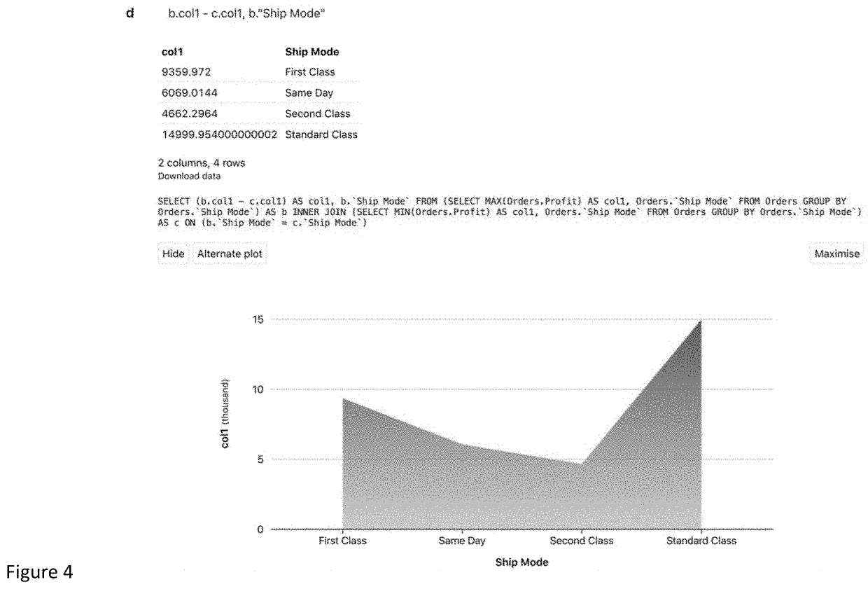

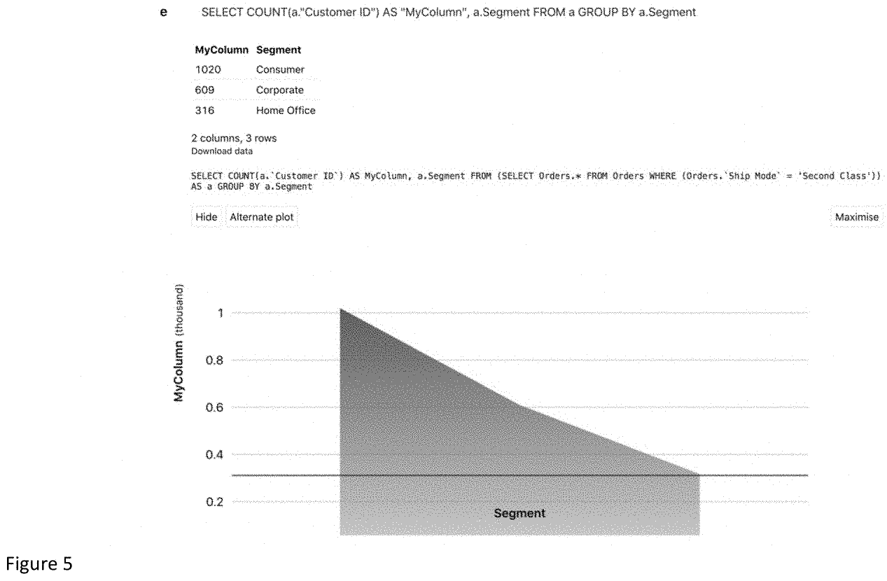

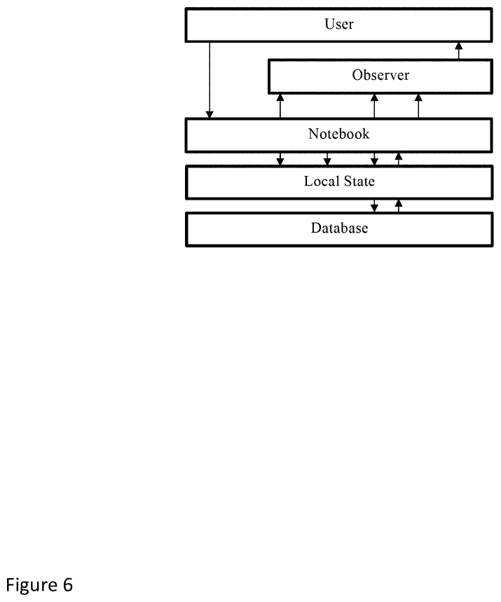

See FIG. 4. When the user interacts with the notebook—time moves from left to right.

The Database, Local State, Notebook and Observer are all on the server. The User is remote.

Note that:
1) There are a minimal number of communications with the user, this reduces the amount of network usage—the observer is used to stash the behaviour which needs returning to the user
2) The notebook controls the local state, which is largely independent of the database, which is only called when results are required outside of the behaviour that can be predicted or the results need to be displayed
3) The database calls can be made after all manipulations involving the local state or during, depending on the profile of the system.

### APPENDIX F: GENERATING SUGGESTIONS

Builders

Builders are deterministic suggestions based on the contents of a layer, and possibly one or more layers coming before it; examples include:
1) Providing extended functions based on the input to the previous layer, for example:
   a. *Box plots: In addition to returning just the average, return the values i.e. the quartiles, some high and low centiles and the outliers needed for a box plot
   b. *Distribution functions: Returning the CDF, the fractional or percentage CDF, and PDF of a variable
   c. *Distinct values: Returning the distinct tuples of values that the selected columns take; for non-categorical columns either binning or aggregation can be used
   d. Moving window functions: For example, *exponential moving average, seasonal adjustment
   e. *Normalisation: Normalising the result of a layer to either some aggregator on the values e.g.
      i. their SUM,
      ii. their sum over a subset of the columns which are aggregated by
      iii. the integral over a non-categorical variable
   f. *Ranking the results of the previous layer, providing an explicit ‘Rank’ column
   g. *Rebasing
      i. Rebasing a date column, such that it becomes e.g. ‘days since . . . ’
   h. *Zoom out: move a column from the filter into the GROUP BY and remove that term from the filter e.g. average sales where city=London gives average sales by city
   i. *For cases where the previous expression contains an aggregator which returns a value which exists in the data (e.g. MAX, MIN, MEDIAN, but not mean which may not be in the list of numbers from which the mean was found) apply the filter to obtain those rows with the value e.g. Maximum sales by region gives records with sales=the maximum sales in their region.
2) Modification to the input to the current layer based on the previous layer
   a. Appending the expression entered in the current layer exactly to the previous layer
      i. *Applying filters from one layer to the previous one
      ii. Adding expressions to the list of columns to be grouped by or selected
   b. Modifying the expression in the current layer to refer to an expression in or result of the previous layer
      i. *Applying the filter to the previous layer using a numerical column to refer to the aggregator which contains it, creating a HAVING statement e.g. Maximum sales by region then sales >100 returning regions where the maximum sales >100
   c. Substitution of the expression in the current layer into the previous layer
      i. For example: replacing a column of the same type in the previous layer: average sales in London then profit giving average profit in London
   d. Including the result of the previous layer as an implied expression in the current layer
      i. For example: Maximum sales by region then >100 giving Regions where the Maximum sales >100 or records with the region where maximum sales >100
   e. In each case the previous and current layer can be interchanged
3) Modification to the input to the current layer based on a previous 2 layers
   a. Including the results of two previous layers as implied expressions in the current layer
      i. Average sales by region then Average sales in London then divide giving the ratio between Average sales by region and Average sales in London
   b. *The same as the above, but without needing to enter ‘divide’, a difference by a filter or the presence of two phrases which contain a commonly factorable concept causing this operation or an equivalent (e.g. subtract) to be suggested
   c. In each case the current layer can be interchanged with one of the previous layers
4) Note that
   a. The determination of which operation to perform can take into account more than the source of information, i.e. we could determine which of the options in (1) to perform using more than just the current layer.
   b. * are currently implemented

1. A database query and visualisation system that is configured (i) to provide an interface with which a user can specify one or more queries; (ii) to generate a response to each query which is displayed as a table, graph or other visual representation; and in which the system is configured to process each query as a layer, where a layer is a node in a directed graph, and a set of nodes forms a notebook.

2. The database query and visualisation system of claim 1 in which the notebook is made up of one or more layers, and each layer generally corresponds to a step in the query.

3. The database query and visualisation system of claim 1 in which the notebook is presented vertically down a scrollable page.

4. The database query and visualisation system of claim 1 in which the notebook is presented as a dashboard.

5. The database query and visualisation system of claim 1 in which a query in a layer is represented as a combination of some or all of:
6) SQL (or other database query language) statements
7) SQL (or other database query language) expressions
8) Free text which can be mapped to (1) or (2) by semantic substitution
9) Free text
10) Interface controls (such as click-, touch-, AR-, VR-based controls)

6. The database query and visualisation system of claim 1 in which a query in a layer is transformed into an exact, unambiguous, query in a database query language, such as SQL.

7. The database query and visualisation system of claim 1 in which the type of input is specified by the user or inferred by the system.

8. The database query and visualisation system of claim 1 in which, in cases in which the system infers the type of input, a query in a layer is deterministically filtered for SQL or other database query language statements.

9. The database query and visualisation system of claim 1 in which a query in a layer is deterministically filtered for SQL or other database query language expressions.

10. The database query and visualisation system of claim 1 in which a query in a layer is deterministically filtered for free text which is mapped by semantic substitution to SQL or other database query language statements or expressions.

11. The database query and visualisation system of claim 1 in which a query in a layer is parsed as free text to a database query.

12. The database query and visualisation system of claim 1 in which either or both of (i) an exact query, being a query in a layer that has been transformed into an exact, unambiguous, query in a database query language, such as SQL and (ii) an interpretation of that query into a form which is understandable by a person with no knowledge of database query languages, are displayed to the user.

13. The database query and visualisation system of claim 1 in which the layer provides the user with an interface to query the database using entities from the data which have been imported from the results or other contents of previous layers.

14. The database query and visualisation system of claim 1 in which layers are configured to reference one another, enabling the user to construct increasingly complex queries.

15. The database query and visualisation system of claim 1 in which any update to a layer by the user or the system causes an update of any part of the notebook that is causally dependent on the updated layer.

16. The database query and visualisation system of claim 1 in which a layer holds a local state between update operations precipitated by a user or the notebook.

17. The database query and visualisation system of claim 16 in which the local state of a layer includes the name of the layer and the query represented by the layer, as constructed by the user.

18. The database query and visualisation system of claim 1 in which, from the name of the layer and the query represented by the layer, as constructed by the user, the system derives the database query to be run, any errors or warnings, and, using a database, the results of the query.

19. The database query and visualisation system of claim 1 in which the notebook locally tracks a schema of the query results from its layers and how those results interconnect.

20. The database query and visualisation system of claim 1 in which the layers can either be created by the system based on existing layers in the notebook or created or modified by the user.

21. The database query and visualisation system of claim 1 in which a layer is configured to automatically insert joins into an input query.

22. The database query and visualisation system of claim 1 in which a layer is configured to automatically insert joins into an input query to execute an assumption that is implicit to the query.

23. The database query and visualisation system of claim 1 in which a layer is configured to automatically insert additional expressions into an input query to execute an assumption that is implicit to the query, or which is explicitly or implicitly required by causally dependent parts of the notebook.

24. The database query and visualisation system of claim 1 in which layers receive information from the notebook which allows them to automatically insert joins or expressions into the queries and to provide suggestions and charts in the context of the surrounding layers.

25. The database query and visualisation system of claim 1 in which queries sent to the database obtain any additional information required for the tracking of joins or other information needed to provide the notebook experience even when that information is neither requested by, nor displayed to, the user.

26. The database query and visualisation system of claim 1 in which the notebook and layers are configured to hold substantially all of the state information, so that the database can be used as if it is stateless with respect to the notebook.

27. The database query and visualisation system of claim 1 in which the notebook controls the local state, which is largely independent of the database, and the database is only called when results are required outside of the behaviour that can be predicted, or when the results need to be displayed.

28. The database query and visualisation system of claim 1 in which the notebook does not rely on storing or caching of any data from the database itself; and results to queries are retrieved from the database and returned to the user directly.

29. The database query and visualisation system of claim 1 in which the notebook simulates behaviour of the database using knowledge of the database schema.

30. The database query and visualisation system of claim 1 in which tables and visuals presented in response to a database query are automatically generated by the system or customised by the user or both.

31. The database query and visualisation system of claim 1 in which the system is configured to enable a user to add rich content to the notebook, including text and/or media, which is programmed to update dynamically based on the results of layers in the notebook.

32. The database query and visualisation system of claim 1 in which the system acts to simulate a connection to another system, using some information about the result of an action on another system, with a substantially reduced need to test that remote system.

33. The database query and visualisation system of claim 1 in which the system allows complex operations to be built up iteratively, with the validity of a given series of operations evaluable with complete recall.

34. The database query and visualisation system of claim 1 in which the system allows for the action on the system to be deferred until such a time as the result of the action needs to be known.

35. The database query and visualisation system of claim 1 in which the system is configured such that the computational time needed to calculate an upper bound, a lower bound or validate that a prohibitive condition has not been triggered is significantly lower than that needed to find the actual answer.

36. The database query and visualisation system of claim 1 in which the system is configured to run on a computer, a local computer, a server, a cloud-based computing system, a distributed client-server computing system, or any combination of these.
